(19) United States
(12) Patent Application Publication
(10) Pub. No.: US 2011/0280604 A1
(43) Pub. Date: Nov. 17, 2011

(54) IMAGE FORMING APPARATUS AND IMAGE FORMING METHOD

(75) Inventor: Kazufumi Ishida, Shizuoka (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/090,308

(22) Filed: Apr. 20, 2011

Related U.S. Application Data
(60) Provisional application No. 61/333,376, filed on May 11, 2010.

(51) Int. Cl. G03G 15/00; G03G 15/02

(52) U.S. Cl. 399/48; 399/50; 399/49

(57) ABSTRACT

According to one embodiment, an image forming apparatus includes: a charging device configured to apply a voltage to a photoconductive drum to set the photoconductive drum to surface potential V0; a laser-beam irradiating unit configured to form an electrostatic latent image having potential Ver on the photoconductive drum; a neutralizing section configured to generate an electrostatic latent image for detection having the potential Ver on the photoconductive drum; a surface-potential detecting section configured to detect the surface potential V0 of the photoconductive drum; a density detecting section configured to detect printing density of a test patch for density measurement; and a control section configured to control, when a contrast potential Vc is adjusted, the surface potential V0 on a negative side at potential equal to or larger than a threshold.

### CROSS-REFERENCE TO RELATED APPLICATIONS

This application is based upon and claims the benefit of priority from the prior the U.S.A. Patent Application No. 61/333,376, filed on May 11, 2010, and the entire contents of which are incorporated herein by reference.

### FIELD

Embodiments described herein relate generally to an image forming apparatus and an image forming method.

### BACKGROUND

An electronic image forming apparatus such as a copying machine or a printer negatively charges a photoconductive drum and irradiates a laser beam on the photoconductive drum to reduce the potential in a section where an image is formed. When a negatively charged developer is supplied to the photoconductive drum, the developer adheres to only the section having the reduced potential and a developer image is formed.

The image forming apparatus transfers the developer image onto a recording medium via a transfer belt or directly. The transfer is performed by attracting the negatively charged developer to a positively charged transfer roller.

The behavior of the developer is affected by environmental fluctuation. Specifically, even if potential is adjusted to form a high-quality image in a low-temperature and low-humidity environment, printing density tends to be too high if the environment changes to high temperature and high humidity.

Therefore, in order to maintain the high image quality, it is necessary to adjust the potential applied to the photoconductive drum, the potential that changes according to the irradiation of the laser beam, and the potential applied to the developer.

Concerning this point, there is proposed a technique for providing potential sensors respectively in a position immediately after laser beam exposure, a position immediately after development, and a position immediately after neutralization in the photoconductive drum and changing contrast potential, which is a difference between the potential that changes according to the irradiation of the laser beam and the potential applied to the developer, on the basis of the potentials detected by the sensors.

However, if only the contrast potential is changed, in some case, transfer memory occurs that is a phenomenon in which the influence of a positive voltage applied in the transfer remains on the photoconductive drum and adversely affects image formation performed following the transfer.

Therefore, there is a demand for an image forming apparatus and an image forming method that do not cause transfer memory when the contrast potential is adjusted.

### BRIEF DESCRIPTION OF THE DRAWINGS

FIG. 1 is a diagram of the configuration of an image forming apparatus;

FIG. 2 is a side view of the vicinity of a photoconductive drum;

FIG. 3 is a graph of a relation among potentials;

FIG. 4 is a diagram of a graph indicating a relation among surface potential V0, contrast potential Vc, and a range in which transfer memory occurs; and

FIG. 5 is a block diagram of the configuration of the image forming apparatus.

### DETAILED DESCRIPTION

Throughout this description, the embodiments and examples shown should be considered as exemplars, rather than limitations on the apparatus and methods of the present embodiments.

Exemplary embodiments are explained in detail below with reference to the accompanying drawings. In the following explanation, examples of an image forming apparatus include a copying machine, a MFP (Multifunction Peripheral), and a printer.

In general, according to one embodiment, an image forming apparatus includes: an image bearing member; a charging section configured to uniformly charge the image bearing member; an exposing section configured to expose the image bearing member to light and form an electrostatic latent image on the image bearing member; a developer carrying member configured to supply a developer to the electrostatic latent image formed on the image bearing member; a development-bias-voltage applying section configured to apply a bias voltage to the developer carrying member; a transfer section configured to transfer a developer image formed on the image bearing member onto a transfer material; a transfer-bias-voltage applying section configured to apply a transfer bias voltage having polarity opposite to the polarity of the charging by the charging section to the transfer section; a surface-potential detecting section configured to detect the surface potential of the image bearing member; and a control section configured to control, when a difference between the bias voltage applied to the developer carrying member and the potential of the image bearing member is adjusted, if an absolute value of the surface potential detected by the surface-potential detecting section is smaller than a threshold, the charging by the charging section to increase the absolute value of the surface potential to be equal to or larger than the threshold.

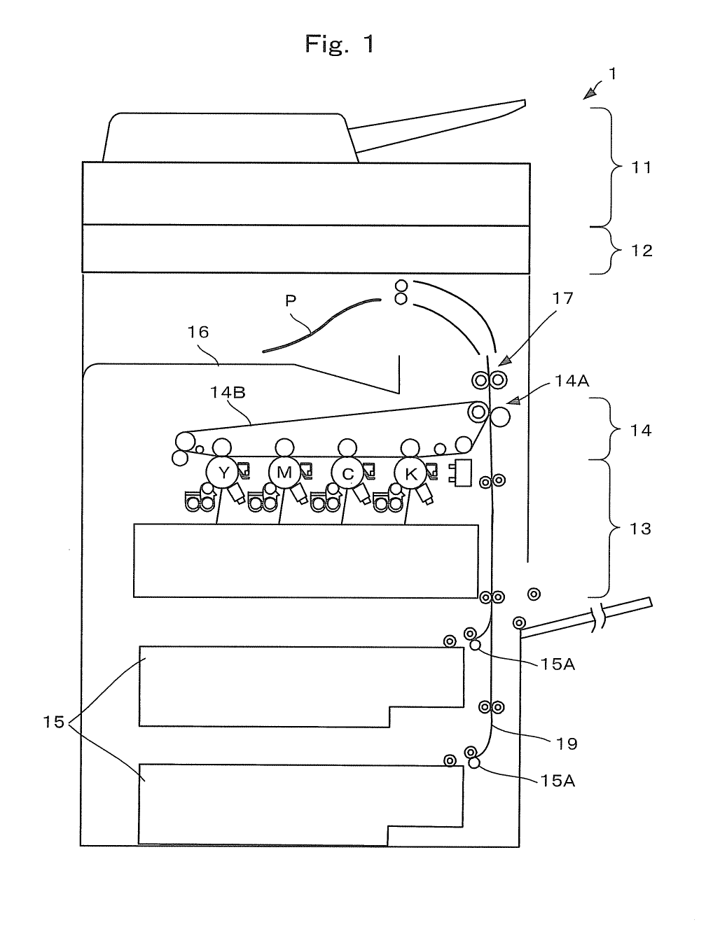

FIG. 1 is a diagram of the configuration of an image forming apparatus 1 according to an embodiment. As shown in FIG. 1, the image forming apparatus 1 includes an auto document feeder 11, an image reading section 12, an image forming section 13, a transfer section 14, a recording-medium conveying mechanism 19, and a paper feeding unit 15.

The image forming apparatus 1 includes the auto document feeder 11 openably and closably provided in an upper part of a main body of the image forming apparatus 1. The auto document feeder 11 includes a document conveying mechanism configured to extract documents from a paper feeding tray one by one and convey the document to a paper discharge tray.

The auto document feeder 11 conveys, with the document conveying mechanism, the documents to a document reading section of the image reading section 12 one by one. It is also possible to open the auto document feeder 11 and place a document on a document table of the image reading section 12.

The image reading section 12 includes a carriage including an exposure lamp configured to expose a document to light and a first reflection mirror, plural second reflection mirrors locked to a main body frame of the image forming apparatus 1, a lens block, and a CCD (Charge Coupled Device) of an image reading sensor.

The carriage stands still in the document reading section or reciprocatingly moves under the document table to reflect the light of the exposure lamp, which is reflected by the document, to the first reflection mirror. The plural second reflection mirrors reflect the reflected light of the first reflection mirror to the lens block. The lens block outputs the reflected light to the CCD. The CCD converts the incident light into an electric signal and outputs the electric signal to the image forming section 13 as an image signal.

The image forming section 13 includes, for each of yellow Y, magenta M, cyan C, and black K, a laser irradiating unit, a photoconductive drum serving as an image bearing member, and a developing roller serving as a developer carrying member configured to supply a developer to the photoconductive drum.

The laser irradiation unit serving as an exposing section irradiates a laser beam on the photoconductive drum on the basis of the image signal and forms an electrostatic latent image on the photoconductive drum. The developing roller supplies the developer to the photoconductive drum and forms a developer image from the electrostatic latent image.

The recording-medium conveying mechanism 19 includes, most upstream on the paper feeding unit 15 side, pickup mechanisms 15A configured to extract recording media one by one.

The pickup mechanisms 15A extract recording media from the paper feeding unit 15 one by one and pass the recording medium to the recording-medium conveying mechanism 19. The recording-medium conveying mechanism 19 conveys the recording medium to the transfer section 14.

The transfer section 14 includes a transfer belt 14B, a transfer roller 14A serving as a transfer-bias-voltage applying unit configured to apply a transfer bias voltage having polarity opposite to the polarity of charging by the charging section to the transfer section, and a fixing device 17. The transfer belt 14B is wound around an opposed roller opposed to the transfer roller 14A. The transfer belt 14B serving as an image bearing member receives the transfer of the developer image on the photoconductive drum and bears the developer image. The transfer roller 14A applies a voltage to the developer image on the transfer belt 14B and transfers the developer image onto a recording medium conveyed to the transfer roller 14A. The fixing device 17 heats and presses the developer image and fixes the developer image on the recording medium.

In another embodiment, the image forming apparatus 1 directly transfers the developer image from the photoconductive drum onto the recording medium. In this case, the transfer roller 14A is arranged to be opposed to the photoconductive drum.

A recording medium P discharged from a paper discharge port is stacked on a paper discharge tray 16 serving as a carrying section configured to carry the recording medium.

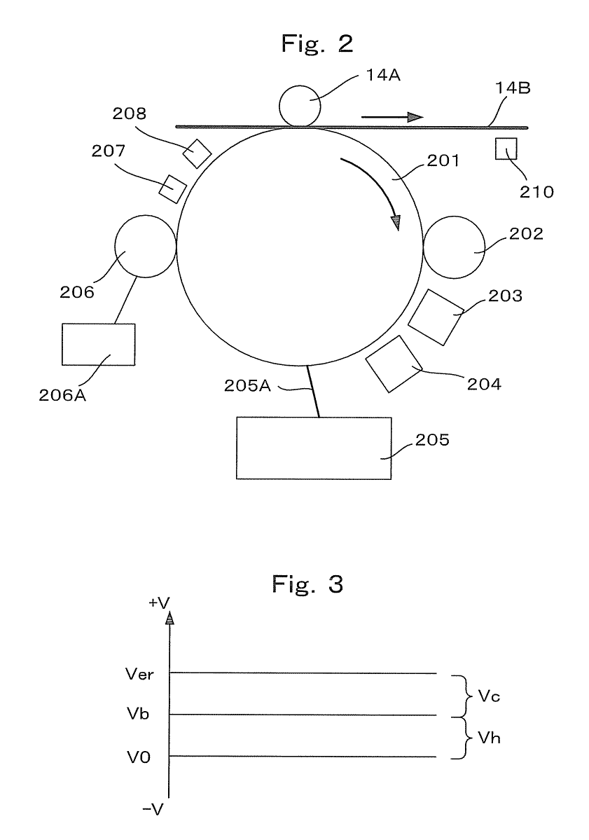

FIG. 2 is a side view of the vicinity of a photoconductive drum 201. As shown in FIG. 2, the image forming apparatus 1 includes, from upstream to downstream in a rotating direction of the photoconductive drum 201, a cleaning section 202 configured to scrape a remaining developer off the photoconductive drum 201, a residual-potential neutralizing section 203 configured to neutralize potential remaining on the photoconductive drum 201, a charging section 204 configured to uniformly charge the photoconductive drum 201 to surface potential V0, a laser-beam irradiating unit 205 configured to irradiate a laser beam 205A on the photoconductive drum 201, a developing roller 206 configured to supply a developer to an electrostatic latent image formed when potential is changed to Ver by the laser beam 205A, a development-bias-voltage applying section 206A configured to apply a bias voltage Vb to the developing roller 206, a neutralizing section 207 configured to neutralize the surface potential V0 of the photoconductive drum 201 having the potential V0 to the potential Ver, a surface-potential detecting section 208 configured to detect the potential of the surface of the photoconductive drum 201, and a transfer roller 14A configured to apply a positive voltage and transfer a developer image.

The image forming apparatus 1 includes, downstream in a rotating direction of the transfer belt 14B from a transfer position of the transfer belt 14B and on the photoconductive drum 201 side, a density detecting section 210 configured to detect printing density of a test patch for density measurement.

In other words, the image forming apparatus 1 includes the surface-potential detecting section 208 downstream in the rotating direction of the photoconductive drum 201 from the developing roller 206 of the surface-potential detecting section 208 and upstream in the rotating direction of the photoconductive drum 201 from the transfer roller 14A.

The image forming apparatus 1 includes the neutralizing section 207 downstream in the rotating direction of the photoconductive drum 201 from the developing roller 206 and upstream in the rotating direction of the photoconductive drum 201 from the surface-potential detecting section 208.

Since the image forming apparatus 1 includes the neutralizing section 207 in this position, it is possible to prevent a neutralizing effect by the neutralizing section 207 from being affected by the developing roller 206.

A type of the neutralizing section 207 may be any type as long as the neutralizing section 207 can neutralize the potential of the photoconductive drum 201 to the potential Ver, which is a potential changed according to the laser beam 205A. For example, an LED or a laser beam emitting device can be used.

FIG. 3 is a graph of a relation among potentials. As shown in FIG. 3, a bias voltage Vb, which is a voltage applied to the developing roller 206 in order to charge a developer, is potential further on the positive side than the surface potential V0.

The potential Ver in a neutralizing region by the laser beam 205A is potential further on the positive side than the bias voltage Vb.

A difference between the potential Ver in the neutralizing region by the laser beam 205A and the bias voltage Vb is referred to as contrast potential Vc. In other words, Vc=|Vb−Ver|.

A difference between the surface potential V0 and the bias voltage Vb is referred to as background potential Vh. In other words, Vh=|V0−Vb|.

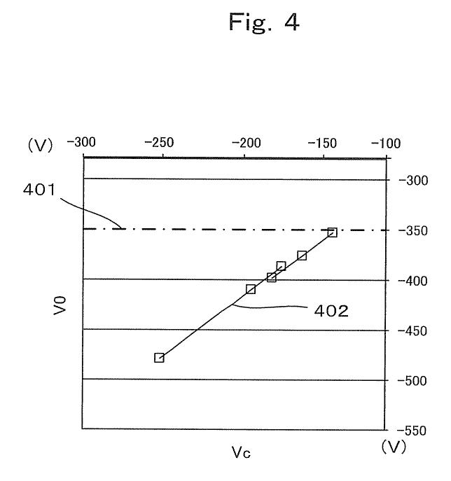

FIG. 4 is a diagram of a graph 402 indicating a relation among the surface potential V0, the contrast potential Vc, and a range in which transfer memory occurs. As shown in FIG. 4, in order to perform satisfactory image formation, if the contrast potential Vc is reduced, it is necessary to adjust the surface potential V0 further to the positive side. This is because, since the background potential Vh is too large, an image to be formed is faint as a whole.

However, if the surface potential V0 is adjusted excessively to the positive side, transfer memory occurs that is a phenomenon in which the influence of the positive voltage applied in transfer remains on the photoconductive drum 201 and adversely affects image formation performed following the transfer.

Transfer memory occurs if the surface potential V0 is further on the positive side than a threshold 401 in FIG. 4.

The image forming apparatus 1 controls the surface potential V0 to be further on the negative side if the surface potential V0 is further on the positive side than the threshold 401 when the contrast potential Vc is reduced. Controlling the surface potential V0 to be further on the negative side means raising potential to the negative side to increase an absolute value of the surface potential V0.

Specifically, the image forming apparatus 1 cleans the photoconductive drum 201 with the cleaning section 202, neutralizes the photoconductive drum 201 with the residual-potential neutralizing section 203, and charges the photoconductive drum 201 with the charging section 204.

The image forming apparatus 1 neutralizes, without irradiating the laser beam 205A, the photoconductive drum 201 to the potential Ver with the neutralizing section 207 in a region having a size same as the size of the test patch and generates an electrostatic latent image for detection.

The image forming apparatus 1 detects, with the surface-potential detecting section 208, the surface potential V0 and the potential Ver of the electrostatic latent image for detection neutralized by the neutralizing section 207.

The image forming apparatus 1 calculates approximate contrast potential Vc′, which is an approximate value of the contrast potential Vc, and the background potential Vh from the bias voltage Vb, the detected surface potential V0, and the potential Ver of the electrostatic latent image for detection neutralized by the neutralizing section 207.

The image forming apparatus 1 forms the test patch and transfers the test patch onto the transfer belt 14B. Subsequently, the image forming apparatus 1 detects printing density of the test patch with the density detecting section 210.

If the image forming apparatus 1 determines that the printing density of the test patch is lower than a specified value, the image forming apparatus 1 increases the contrast potential Vc to be larger than the approximate contrast potential Vc′ on the basis of the approximate contrast potential Vc′. If the image forming apparatus 1 determines that the printing density of the test patch is higher than the specified value, the image forming apparatus 1 reduces the contrast potential Vc to be smaller than the approximate contrast potential Vc′

If the image forming apparatus 1 reduces the bias voltage Vb on the positive side to reduce the contrast potential Vc, the image forming apparatus 1 reduces the surface potential V0 on the positive side in order to set the background potential Vh to a specified value.

In other words, in adjusting the magnitude of the contrast potential Vc, if the image forming apparatus 1 determines that the surface potential V0 is lower than the threshold, the image forming apparatus 1 increases the background potential Vh to be larger than the present value.

If the image forming apparatus 1 reduces the contrast potential Vc, consequently, the approximate contrast potential Vc′ also decreases. Therefore, the contrast potential Vc can be predicted from the approximate contrast potential Vc′.

The image forming apparatus 1 determines whether the reduced surface potential V0 is lower than the threshold, i.e., is on the positive side. If the image forming apparatus 1 determines that the reduced surface potential V0 is lower than the threshold, the image forming apparatus 1 increases the surface potential V0 to be higher than the threshold.

For confirmation, the image forming apparatus 1 may detect the surface potential V0 once more according to the procedure explained above.

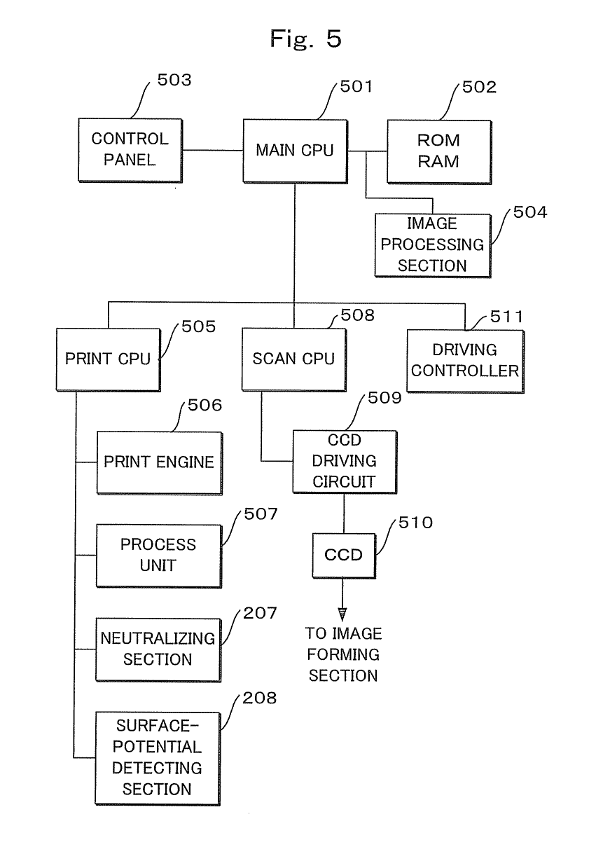

FIG. 5 is a block diagram of the configuration of the image forming apparatus 1. As shown in FIG. 5, the image forming apparatus 1 includes a main CPU 501 serving as a control section, a control panel 503 serving as a display input device, a ROM and RAM 502 serving as a storage device, and an image processing section 504 configured to perform image processing.

The main CPU 501 is connected to and controls a print CPU 505, a scan CPU 508, and a driving controller 511 included in the image forming apparatus 1.

The print CPU 505 is connected to and controls a print engine 506 configured to perform image formation and a process unit 507 including a transfer device.

The print CPU 505 is connected to the neutralizing section 207 and controls the operation of the neutralizing section 207.

The print CPU 505 receives input of an output from the surface-potential detecting section 208 and controls the bias voltage Vb of the developing roller 206 included in the process unit 507, the surface potential Ver of the photoconductive drum 201, and the laser-beam irradiating unit 205 configured to irradiate the laser beam 205A for generating a region having the potential Ver on the photoconductive drum 201.

When the contrast potential Vc is adjusted, the control section controls the surface potential V0 to be kept on the negative side at potential higher than the threshold.

The scan CPU 508 controls a CCD driving circuit 509 configured to drive a CCD 510. An output of the CCD 510 is output to the image forming section.

The driving controller 511 controls the recording-medium conveying mechanism 19.

As explained above, the image forming apparatus 1 according to this embodiment includes the photoconductive drum 201 serving as an image bearing member, the charging section 204 configured to apply a voltage to the photoconductive drum 201 and set the potential of the photoconductive drum 201 to the surface potential V0, the laser-beam irradiating unit 205 configured to form an electrostatic latent image having the potential Ver on the photoconductive drum 201, the developing roller 206 configured to supply a developer to the photoconductive drum 201, the neutralizing section 207 provided downstream in the rotating direction of the photoconductive drum 201 from the developing roller 206 and upstream of the transfer roller 14A and configured to generate an electrostatic latent image for detection having the potential Ver on the photoconductive drum 201, the surface-potential detecting section 208 provided downstream in the rotating direction of the photoconductive drum 201 from the neutralizing section 207 and upstream of the transfer roller 14A and configured to detect the surface potential V0 of the photoconductive drum 201, the density detecting section 210 provided downstream in the rotating direction of the transfer belt 14B in the transfer position of the transfer belt 14B and on the photoconductive drum 201 side and configured to detect printing density of a test patch for density measurement, and the control section configured to control, when the contrast potential Vc is adjusted, the surface potential V0 to be kept on the negative side such that an absolute value of the surface potential V0 is equal to or larger than a threshold.

Therefore, there is an effect that the image forming apparatus 1 can control, when the contrast potential Vc is adjusted, the surface potential V0 not to cause transfer memory.

While certain embodiments have been described, these embodiments have been presented by way of example only, and are not intended to limit the scope of the inventions. Indeed, the novel methods and apparatuses described herein may be embodied in a variety of other forms; furthermore, various omissions, substitutions and changes in the form of the methods and systems described herein may be made without departing from the spirit of the inventions. The accompanying claims and their equivalents are indeed to cover such forms or modifications as would fall within the scope and spirit of the inventions.

What is claimed is:

1. An image forming apparatus comprising:
an image bearing member;
a charging section configured to uniformly charge the image bearing member;
an exposing section configured to expose the image bearing member to light and form an electrostatic latent image on the image bearing member;
a developer carrying member configured to supply a developer to the electrostatic latent image formed on the image bearing member;
a development-bias-voltage applying section configured to apply a bias voltage to the developer carrying member;
a transfer section configured to transfer a developer image formed on the image bearing member onto a transfer material;
a transfer-bias-voltage applying section configured to apply a transfer bias voltage having polarity opposite to polarity of the charging by the charging section to the transfer section;
a surface-potential detecting section configured to detect the surface potential of the image bearing member; and
a control section configured to control, when a difference between the bias voltage applied to the developer carrying member and potential of the image bearing member is adjusted, if an absolute value of the surface potential detected by the surface-potential detecting section is smaller than a threshold, the charging by the charging section to increase the absolute value of the surface potential to be equal to or larger than the threshold.

2. The apparatus according to claim 1, further comprising a neutralizing section further upstream than the surface-potential detecting section and further downstream than the developer carrying member along a rotating direction of the image bearing member.

3. The apparatus according to claim 2, further comprising a density detecting section provided downstream in the rotating direction of the image bearing member from a transfer position of the image bearing member and on the image bearing member side and configured to detect printing density of a test patch for density measurement, wherein
the control section controls, when the difference between the bias voltage applied to the developer carrying member and the potential of the image bearing member is adjusted on the basis of the density detected by the density detecting section, potential of the electrostatic latent image for detection, and the bias voltage, if the absolute value of the surface potential detected by the surface-potential detecting section is smaller than the threshold, the charging by the charging section to increase the absolute value of the surface potential to be equal to or larger than the threshold.

4. The apparatus according to claim 3, wherein the control section sets, if the control section determines that the printing density of the test patch is lower than a specified value, the difference between the bias voltage applied to the developer bearing member and the potential of the image bearing member larger than a difference between the bias voltage applied to the developer bearing member and the potential of the electrostatic latent image for detection and sets, if the control section determines that the printing density of the test patch is higher than the specified value, the difference between the bias voltage applied to the developer bearing member and the potential of the image bearing member smaller than the difference between the bias voltage applied to the developer bearing member and the potential of the electrostatic latent image for detection.

5. The apparatus according to claim 3, wherein the control section sets, when the difference between the bias voltage applied to the developer bearing member and the potential of the image bearing member is adjusted, if the control section determines that the surface potential is lower than the threshold, background potential, which is a difference between the bias voltage and the surface potential, larger than a present value.

6. An image forming method for an image forming apparatus comprising:
detecting surface potential of an image bearing member with a surface-potential detecting section provided downstream in a rotating direction of the image bearing member from a developer carrying member configured to supply a developer to the image bearing member and upstream in the rotating direction of the image bearing member from a transfer roller configured to apply voltage and transfer a developer image on the image bearing member onto the image bearing member; and
controlling, when a difference between a bias voltage applied to the image bearing member and potential of an electrostatic latent image is adjusted, if an absolute value of the surface potential detected by the surface-potential detecting section is smaller than a threshold, charging by a charging section to increase the absolute value of the surface potential to be equal to or larger than the threshold.

7. The method according to claim 6, further comprising:
generating an electrostatic latent image for detection on the image bearing member with a neutralizing section provided downstream in the rotating direction of the image bearing member from a developer carrying member and upstream in the rotating direction of the image bearing member from the surface-potential detecting section;
detecting potential of the electrostatic latent image for detection and the surface potential with the surface-potential detecting section; and
controlling, when a difference between a bias voltage applied to the developer carrying member and potential of the image bearing member is adjusted on the basis of the potential of the electrostatic latent image for detection and the basis voltage, if the absolute value of the surface potential detected by the surface-potential detecting section is smaller than the threshold, charging by the charging section to increase the absolute value of the surface potential to be equal to or larger than the threshold.

8. The method according to claim 7, further comprising:
detecting printing density of a test patch for density measurement with a density detecting section set downstream in the rotating direction of the image bearing member from a transfer position of the image bearing member and on the image bearing member side; and
controlling, when the difference between the bias voltage applied to the developer carrying member and the potential of the image bearing member is adjusted on the basis of the density detected by the density detecting section, potential of the electrostatic latent image for detection, and the bias voltage, if the absolute value of the surface potential detected by the surface-potential detecting section is smaller than the threshold, the charging by the charging section to increase the absolute value of the surface potential to be equal to or larger than the threshold.

9. The method according to claim 7, further comprising:
setting, if it is determined that the printing density of the test patch is lower than a specified value, the difference between the bias voltage applied to the developer bearing member and the potential of the image bearing member larger than a difference between the bias voltage applied to the developer bearing member and the potential of the electrostatic latent image for detection; and
setting, if it is determined that the printing density of the test patch is higher than the specified value, the difference between the bias voltage applied to the developer bearing member and the potential of the image bearing member smaller than the difference between the bias voltage applied to the developer bearing member and the potential of the electrostatic latent image for detection.

10. The method according to claim 7, further comprising setting, when the difference between the bias voltage applied to the developer bearing member and the potential of the image bearing member is adjusted, if it is determined that the surface potential is lower than the threshold, background potential, which is a difference between the bias voltage and the surface potential, larger than a present value.

11. The method according to claim 8, further comprising setting, when the difference between the bias voltage applied to the developer bearing member and the potential of the image bearing member is adjusted, if it is determined that the surface potential is lower than the threshold, background potential, which is a difference between the bias voltage and the surface potential, larger than a present value.
